(19) United States
(12) Patent Application Publication
(10) Pub. No.: US 2020/0079555 A1
(43) Pub. Date: Mar. 12, 2020

(54) TUBE FOR PACKAGING SOLUBLE COFFEE

(71) Applicant: Sudden Coffee, Inc., San Francisco, CA (US)

(72) Inventors: Umeko Motoyoshi, Oakland, CA (US); Joshua Zloof, San Francisco, CA (US); Kalle Freese, San Francisco, CA (US)

(21) Appl. No.: 16/563,245

(22) Filed: Sep. 6, 2019

Related U.S. Application Data
(60) Provisional application No. 62/728,043, filed on Sep. 6, 2018.

(51) Int. Cl. B65D 43/02; B65D 25/34; B65B 29/02; A23F 5/04; A23F 5/08; A23F 5/10; A23F 5/24

(52) U.S. Cl. CPC B65D 43/0229; B65D 25/34; B65B 29/02; B65D 2203/02; A23F 5/08; A23F 5/105; A23F 5/24; A23F 5/04

(57) ABSTRACT

A container is disclosed for packaging and storing coffee. The container may take the form of a tube with an open top end and a closed bottom end, where the top may be covered with a cap. The coffee inside the tube may be soluble coffee. The tube may be made with a variety of materials such as polylactide or polypropylene.

### CROSS-REFERENCE TO RELATED APPLICATION

This application claims the benefit of U.S. Provisional Application No. 62/728,043, filed on Sep. 6, 2018, which is hereby incorporated by reference in its entirety.

### BACKGROUND

Coffee is a popular drink enjoyed by many people. Current containers for holding coffee are inadequate because they make the process of making and using coffee difficult. It would be desirable to create better packaging for coffee.

### SUMMARY OF THE INVENTION

Some embodiments herein are directed to a tube container for holding soluble coffee and methods for packaging soluble coffee in the tube. Other embodiments may relate to a tube container for other forms of coffee like coffee grounds or coffee beans.

One embodiment relates to a plastic container for packaging a portion of soluble coffee. The container may comprise a hollow, cylindrical tube, the tube having a first end and a second end, the first end comprising a circular mouth and the second end comprising a curved closure. A label may be attached to the tube. The tube may include a cap. The interior of the tube may contain soluble coffee.

In one embodiment, the tube and the cap are made of a plastic such as polypropylene (PP).

Another embodiment relates to a method of manufacturing soluble coffee and inserting it into a tube container. The method may include roasting a plurality of coffee beans and processing them into grounds. The method may include extracting dissolved coffee solids from the grounds via steam, hot water, or a combination thereof. The method may include precipitating said compounds via centrifuge, freeze-drying, spray-drying, evaporation, or dehydration. The method may include, after the compounds are precipitated into a solid, breaking the solid into grains. The method may include apportioning the grains into packageable portions. The method may include inserting the grains into a tube and inserting a cap into the tube.

### BRIEF DESCRIPTION OF THE DRAWINGS

FIG. 1 is a view of one embodiment of a container for soluble coffee.

FIG. 2 is a view of the embodiment with the cap removed from the mouth of the tube, illustrating the components of the cap and the tube.

FIG. 3 is a flow chart illustrating an exemplary method for manufacturing soluble coffee and inserting it into the container.

### DETAILED DESCRIPTION

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

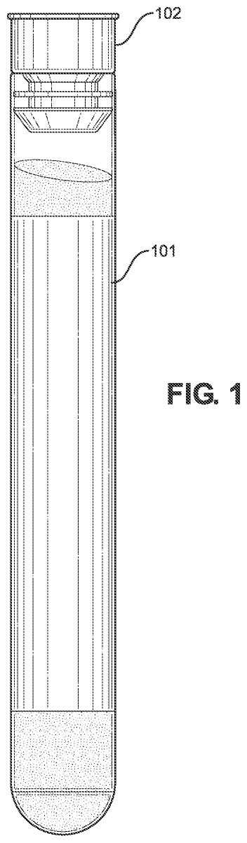

FIG. 1 is a side view of an exemplary container that may be used for packaging soluble coffee or other forms of coffee, such as coffee grounds or roasted or unroasted coffee beans. The container may comprise a hollow, cylindrical tube 101 having an openable and closable top and a hemi-ellipsoidal or hemispheric bottom. In other embodiments, the tube may be prismatic with three, four, five, or more sides parallel to the longitudinal axis of the container and with one end being openable and closable and the other end being flat or pointed.

The container may also include a cap 102, which can be inserted into the tube to create a flush seal. In some embodiments, the seal is airtight when the cap is on. In other embodiments, the seal is permeable and allows air to infiltrate into the container.

The tube and the cap may be made of a variety of materials such as plastic, metal, or other materials. In one embodiment, the tube or cap are made of a plastic, such as polypropylene (PP) or polyethylene (PE). In one embodiment, the tube and cap are made of polypropylene (PP). In one embodiment, the tube and cap are made of polyethylene (PE). In another embodiment, the tube is made of PP and the cap is made of PE, or vice versa. In one embodiment, both the tube and the cap, or at least one of the tube and cap are made of a compostable material, such as polylactide (PLA). In another embodiment, the tube is made of PLA and the cap is made of PE or PP. In some embodiments, the tube or cap are made of compounds where PLA, PP, or PE are an ingredient. The tube and cap may be made of the same material or different materials.

In an embodiment, the container is transparent or translucent to allow viewing the coffee inside the container. The transparent or translucent container may be tinted or un-tinted. In other embodiments, the container is opaque. The material of the container may be patterned or textured, or homogeneous throughout.

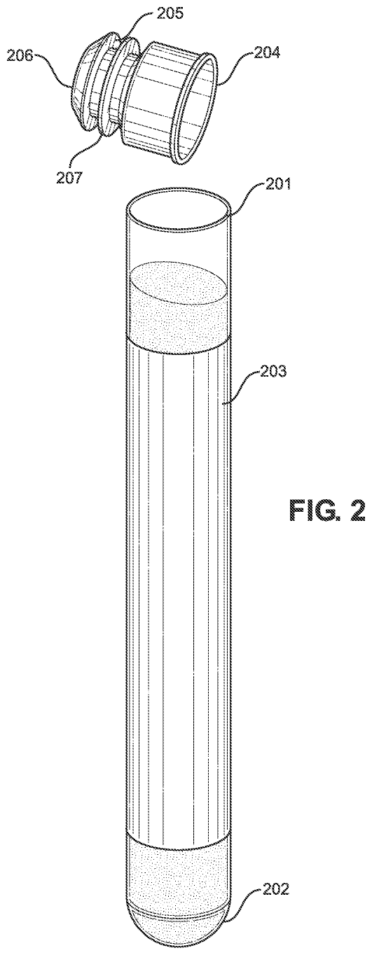

FIG. 2 is a view of the same exemplary container with the cap removed from the mouth of the tube, illustrating the components of the cap and the tube.

In an embodiment, the tube comprises a cylindrical body and has a top end and a bottom end. The top end may comprise an open, circular mouth 201, and the bottom end may comprise a hemi-ellipsoidal closure 202. A label 203 may be attached adhesively to the tube.

In an embodiment, the bottom end of the tube may comprise a flat or curved closure, and the top end may comprise a circular or elliptical mouth, which may be threaded or unthreaded. In other embodiments, the mouth may be rounded, square, rectangular, or polygonal. In some embodiments, the bottom end is rounded, such as hemi-ellipsoidal or hemispherical. A predetermined mass of soluble coffee may be inserted into the tube. In some embodiments, the tube holds a single-serving of soluble coffee, where the single-serving of soluble coffee is suitable for making one cup of coffee when mixed with 6-8 oz, 8-12 oz, 12-16 oz, or 6-12 oz of water. The amount of soluble coffee in the container may comprise, for example, 10-20 ml, 8-15 ml, 10-17 ml, 10-15 ml, 10-12 ml, approximately 10 ml, approximately 11 ml, approximately 12 ml, approximately 13 ml, approximately 14 ml, or approximately 15 ml.

The cap may comprise a threaded skirt 204, which is attached concentrically to a stopper 205 at its base. Two flexible, annular flanges 206 and 207 may be attached to the stopper. The flanges may have a curvature distal to the body of the tube and proximal to the skirt of the cap. Said flanges may have a diameter slightly larger than that of the inner wall of the tube, such that the flanges deform to create a flush seal with the wall of the tube upon inserting the cap into the mouth of the tube. Although two flanges are illustrated, other embodiments may include one flange on the stopper or three, four, or more flanges. In some embodiments, the cap may further comprise a tether, such that when the cap is removed from the mouth of the tube, it remains attached to the tube via the tether. The tether may be made of the same materials as the cap or tube or may be made of other materials.

In an embodiment, the cap is approximately the same diameter as the tube, with a skirt that may be ribbed or smooth. In another embodiment, portions of the cap have a diameter greater than that of the interior of the tube so that the portions are deformed during insertion or are located on the outside of the tube.

The cap may be inserted into the mouth of the tube such that a flush seal is created. The cap may have interior threads such that it can be twisted on to a threaded mouth, or the cap may have a stopper with a geometry that deforms to create a flush seal with the inner wall of the tube, such as a cone, conical segment, or an extruded geometry with tapering or beveling.

The container may also include a label. The label may be made of paper, plastic, or other materials and may be attached to the outside of the tube. In an embodiment, the label is attached by an adhesive on the back of the label. For example, the label may be a sticker that is applied by a machine or a worker. In other embodiments, the label may be attached to the tube using other methods like fasteners, clasps, hook-and-loop fasteners, tape, glue, and other attachment methods. In some embodiments, the label may be painted or printed directly onto the tube. In some embodiments, no label is attached to the tube.

In some embodiments, the tube has a height of 10-300 mm, 20-150 mm, 90-100 mm, 80-110 mm, 70-120 mm, 60-170 mm, 70-150 mm, 70-100 mm, 50-200 mm, 50-150 mm, 50-125 mm, 50-100 mm, 80-90 mm, 70-80 mm, 70-120 mm, or 60-70 mm. In some embodiments, the tube has a height of approximately 75 mm, 92 mm, 100 mm, 125 mm, or 150 mm. In some embodiments, the tube has a thickness of 0.1-5 mm, 0.1-0.5 mm, 0.1-2 mm, 0.5-1 mm, 0.5-3 mm, 1-2 mm, 2-3 mm, 3-4 mm, or 4-5 mm. In some embodiments, the tube has a diameter of 5-50 mm, 10-20 mm, 12-18 mm, 10-12 mm, 12-14 mm, 14-16 mm, 16-18 mm, or 18-20 mm. In some embodiments, the tube has a diameter of approximately 16 mm. In some embodiments, the interior volume of the tube is 10-20 ml, 8-25 ml, 5-30 ml, 5-50 ml, 10-30 ml, or 8-15 ml. In some embodiments, the interior volume of the tube is approximately 10 ml, 11 ml, 13 ml, 14 ml, 17 ml, or 20 ml. In one embodiment, the tube is approximately 16 mm in diameter and 95 mm tall with a wall thickness of approximately 1 mm. In one embodiment, the tube is approximately 16 mm in diameter and 92 mm tall with a wall thickness of approximately 1 mm.

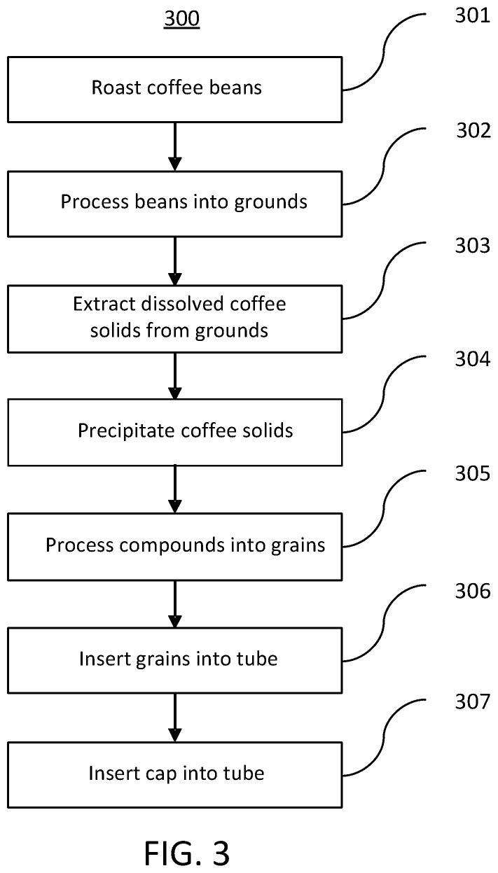

FIG. 3 illustrates a flow chart of an exemplary method 300 that may be performed to manufacture and package soluble coffee in the container.

In one embodiment of the method 300, a plurality of coffee beans is provided. Coffee beans may be of a number of varieties. The coffee beans are roasted (step 301) and then processed into fine grounds (step 302). The processing may be performed using a grinder, blender, or crushing device.

Using steam, hot water, or a combination of steam and hot water, volatile compounds are extracted from the grounds (step 303). The volatile compounds may comprise, for example, dissolved coffee solids, including aromatics. When steam is used, the steam is allowed to condense into a liquid solution of the volatile compounds.

After extraction, the compounds are suspended in a solution of water. The compounds are precipitated out of the solution via centrifuge, freeze-drying, spray-drying, evaporation, or dehydration (step 304). When the compounds are precipitated into a solid, the solid is broken into grains (step 305). When the compounds are precipitated into a fine powder, they may be made into larger grains via steam fusion.

Once the compounds have been processed into grains, the grains are inserted into the mouth of the tube (step 306), and a cap is inserted into the tube to create a flush seal (step 307).

The steps of the method may be performed in different orders than presented above or in the figure.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

While various embodiments of a container for packaging soluble coffee constructed according to the principles disclosed herein, as well as specific components of the container, have been described above, it should be understood that they have been presented by way of example only, and not limitation. Thus, the breadth and scope of the invention should not be limited by any of the above-described exemplary embodiments, but should be defined only in accordance with the following claims and their equivalents.

What is claimed:

1. A container for packaging a portion of soluble coffee, comprising:
a hollow, cylindrical tube comprising polypropylene (PP), the tube having a first end and a second end, the first end comprising a circular mouth and the second end comprising a hemi-ellipsoidal closure;
a label adhesively attached to the outside of said tube, wherein the label is made of paper;
a cap comprising plastic;
wherein the interior of the tube contains soluble coffee.

2. The container of claim 1, wherein said tube has a diameter of approximately 16 mm and a thickness of approximately 1 mm.

3. The container of claim 1, wherein said cap comprises:
an upper skirt of a diameter greater than that of said tube, textured with spaced ribs,
a cylindrical stopper to be inserted into the mouth of the tube, extending concentrically from said skirt.

4. The container of claim 3, wherein said stopper further comprises two flexible, annular flanges, both having a curvature distal to the body of the tube and proximal to the skirt of said cap, both of which are attached concentrically to the stopper.

5. The container of claim 4, wherein said flanges have a maximum diameter slightly greater than the inner diameter of the tube, such that when the stopper is inserted into the mouth of the tube, said flanges deform to create a flush seal with the walls of the tube.

6. The container of claim 1, wherein the tube has a diameter of 5-50 mm and a height of 10-300 mm.

7. The container of claim 1, wherein the tube and the cap include threaded portions.

8. A container for packaging a portion of soluble coffee, comprising:
a hollow, cylindrical tube comprising plastic, the tube having a first end and a second end, the first end comprising a mouth and the second end comprising a curved closure;
a label on said container;
a cap comprising plastic;
wherein the interior of the tube contains soluble coffee.

9. The container of claim 8, wherein said tube has a diameter of approximately 16 mm and a thickness of approximately 1 mm.

10. The container of claim 8, wherein said cap comprises:
an upper skirt of a diameter greater than that of said tube, textured with spaced ribs,
a cylindrical stopper to be inserted into the mouth of the tube, extending concentrically from said skirt.

11. The container of claim 10, wherein said stopper further comprises two flexible, annular flanges, both having a curvature distal to the body of the tube and proximal to the skirt of said cap, both of which are attached concentrically to the stopper.

12. The container of claim 11, wherein said flanges have a maximum diameter slightly greater than the inner diameter of the tube, such that when the stopper is inserted into the mouth of the tube, said flanges deform to create a flush seal with the walls of the tube.

13. The container of claim 8, wherein the tube has a diameter of 5-50 mm and a height of 10-300 mm.

14. The container of claim 8, wherein the tube and the cap include threaded portions.

15. A method for manufacturing and packaging soluble coffee, comprising:
roasting a plurality of coffee beans;
processing said coffee beans into fine grounds;
extracting compounds from said grounds via steam, hot water, or a combination thereof;
precipitating said compounds via centrifuge, freeze-drying, spray-drying, evaporation, or dehydration;
after the compounds are precipitated into a solid, breaking said solid into grains;
apportioning said grains into packageable portions;
inserting said grains into a plastic tube, said tube having a first end and a second end, the first end comprising an open mouth, the second end comprising a hemi-ellipsoidal closure, the tube comprising PP;
inserting the cap of the container into the tube, such that a flush seal is created with the walls of the tube.

16. The method of claim 15, wherein the plastic tube has a diameter of approximately 16 mm and a thickness of approximately 1 mm.

17. The method of claim 15, wherein the cap comprises:
an upper skirt of a diameter greater than that of said tube, textured with spaced ribs,
a cylindrical stopper to be inserted into the mouth of the tube, extending concentrically from said skirt.

18. The method of claim 17, wherein said stopper further comprises two flexible, annular flanges, both having a curvature distal to the body of the tube and proximal to the skirt of said cap, both of which are attached concentrically to the stopper.

19. The method of claim 18, wherein said flanges have a maximum diameter slightly greater than the inner diameter of the tube, such that when the stopper is inserted into the mouth of the tube, said flanges deform to create a flush seal with the walls of the tube.

20. The method of claim 15, wherein the tube has a diameter of 5-50 mm and a height of 10-300 mm.
